(19) United States
(12) Patent Application Publication
(10) Pub. No.: US 2001/0034156 A1
(43) Pub. Date: Oct. 25, 2001

(54) Connector for printed-wiring board

(76) Inventor: Hiroshi Yamane, Yokohama-shi (JP)

Correspondence Address: Jonathan P. Osha, Rosenthal & Osha L.L.P., 700 Louisiana, Suite 4550, Houston, TX, 77044, US

(21) Appl. No.: 09/836,760

(22) Filed: Apr. 17, 2001

(30) Foreign Application Priority Data
Apr. 19, 2000 (JP) 2000-123695

(51) Int. Cl. H01R 12/24; H01R 13/625; H01R 4/50

(52) U.S. Cl. 439/492; 439/342

(57) ABSTRACT

A connector for a printed-wiring board comprising a housing including an accommodating cavity for accommodating an edge portion of said printed-wiring board having a circuit pattern formed thereon; a plurality of contacts which are supported in a plurality of grooves provided in said cavity, respectively, and comes into contact with said circuit pattern of said printed-wiring board while said edge portion of said printed-wiring board is in said cavity; and at least one window formed in said housing that permits at least a part of said printed-wiring board to be visually checked from outside of said housing while said edge portion of said printed-wiring board is in said cavity.

### BACKGROUND OF THE INVENTION

The present invention relates to a connector for printed-wiring board for use in connecting the printed-wiring board to a substrate.

A connector for printed-wiring board for use in connecting the flexible printed-wiring board, such as a flexible printed circuit (FPC) and a flexible flat cable (FFC), is known, which has a housing having an accommodating cavity for accommodating an edge portion of the printed-wiring board, a number of grooves provided in the cavity, and a number of contacts supported in their respective grooves to contact with the circuit pattern of the printed-wiring board.

In this known connector for printed-wiring board, when the edge portion of the printed-wiring board is accommodated in the housing as a plug, the contacts supported in the grooves provided in the cavity come into contact with the terminals of the circuit pattern in the printed-wiring board to secure electrical connection between the both.

The printed-wiring board, such as FPC and FFC, is not rigid, for the reason of which it is hard for an operator to obtain a sure tactile feedback or sense of insertion of the printed-wiring board into the housing of the connector. The operator sometimes has difficulty in ascertaining that the printed-wiring board is suitably inserted into position where the terminals in the printed-wiring board are all in contact with the contacts of the connector. For example, there is the possibility that although the printed-wiring board is inserted in the connector at some tilt with respect to the inserting direction, so that it is put in the partly plugged state (in which some terminals are in contact with the contacts of the connector but others not), the operator may mistake it for completion of the insertion of the printed-wiring board. As a result, failure of connection with respect to the printed-wiring board may be caused. This problem is often caused in a multipolar type connector for the printed-wiring board having a large width, in particular.

### SUMMARY OF THE INVENTION

In view of the above problems, the present invention has been made. It is the main object of the invention to provide a connector for printed-wiring board that can prevent failure of the connection with respect to the printed-wiring board from occurring.

A connector for a printed-wiring board of the present invention comprising a housing including an accommodating cavity for accommodating an edge portion of said printed-wiring board having a circuit pattern formed thereon; a plurality of contacts which are supported in a plurality of grooves provided in said cavity, respectively, and comes into contact with said circuit pattern of said printed-wiring board while said edge portion of said printed-wiring board is in said cavity; and at least one window formed in said housing that permits at least a part of said printed-wiring board to be visually checked from outside of said housing while said edge portion of said printed-wiring board is in said cavity.

In the connector for printed-wiring board of the present invention, it is preferable that at least two windows are located at an interval spaced along the extending direction of the cavity.

In the connector for printed-wiring board of the present invention, at least one window may be formed at a location corresponding to a preset contacting point of the circuit pattern formed in the printed-wiring board and the contacts.

In the connector for printed-wiring board of the present invention, the contacts include two types of contacts, first contacts and second contacts, whose contacting positions with the circuit pattern may be staggered relative to one another in the inserting direction of the printed-wiring board, and the first contacts and the second contacts are alternately supported in the plurality of grooves.

Other and further objects, features and advantages of the invention will appear more fully from the following description taken in connection with the accompanying drawing.

### BRIEF DESCRIPTION OF THE DRAWINGS

FIG. 1 is a perspective view of the entirety of a connector for printed-wiring board before being connected with the printed-wiring board according to an embodiment of the present invention;

FIG. 2 is a perspective view of a housing constructing the connector shown in FIG. 1;

FIG. 3 is a perspective view thereof representing a sectional view taken along line III-III of FIG. 1;

FIG. 4 is a perspective view thereof representing a sectional view taken along line IV-IV of FIG. 1;

FIG. 5 is a perspective view thereof representing a sectional view taken along line V-V of FIG. 1; and

FIG. 6 is a plan view of the connector of printed-wiring board shown in FIG. 1 which is in the state in which the printed-wiring board is inserted in the connector.

### DESCRIPTION OF THE PREFERRED EMBODIMENT

In the following, a connector for printed-wiring board according to one preferred embodiment of the present invention will be described with reference to the accompanying drawings.

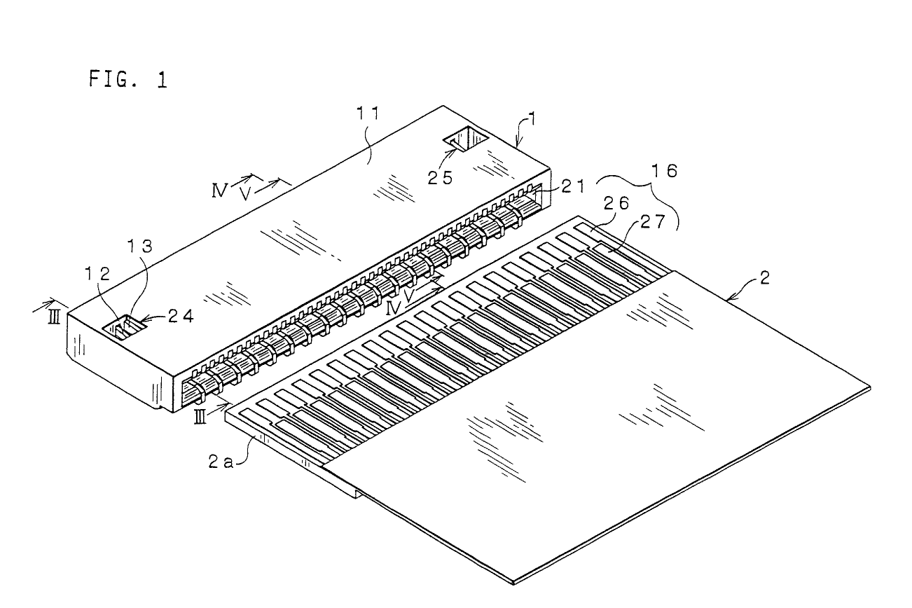

As shown in FIGS. 1, 4 and 5, a connector 1 for printed-wiring board according to an embodiment of the present invention (hereinafter it is simply referred to as “the connector”) comprises a housing 11 and first contacts 12 and second contacts 13 held in the housing 11. A printed-wiring board 2 to be inserted in the connector 1 is flexible as FPC and FFC comprising a thin film or membrane of flexible resin or equivalent having conductors wired in the interior thereof or on the surface thereof. The printed-wiring board 2 has at an edge portion thereof a circuit pattern 16 including a number of first contacts 26 and a number of second contacts 27. The first contacts 26 and the second contacts 27 are alternately arranged with respect to a direction orthogonal to the inserting direction of the printed-wiring board 2 and also are arranged in a staggered way with respect to the inserting direction.

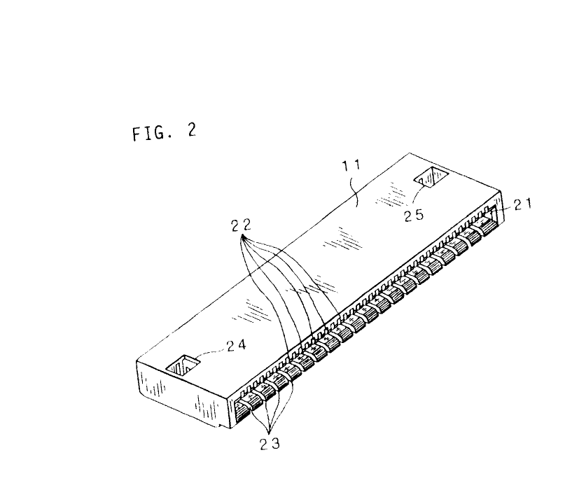

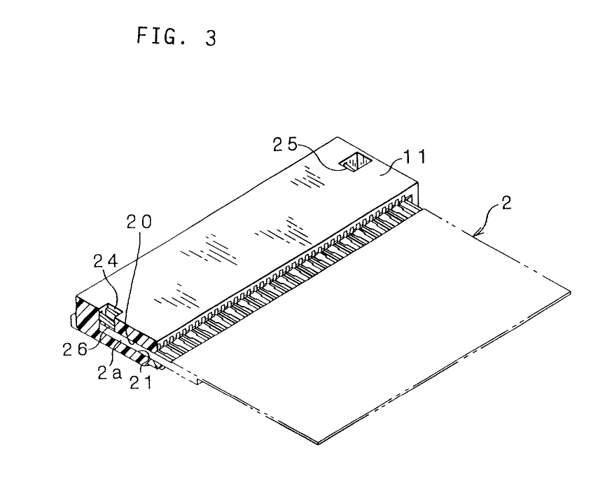

As shown in FIGS. 2, 4 and 5, the housing 11 formed of an insulating material such as LPC has a flat, horizontally elongated, rectangular parallelepiped form and has at one side thereof a generally rectangle-shaped opening (insertion slot) 21 formed in the housing 11 to extend a nearly whole length of the housing 11 along the longitudinal direction thereof. The edge portion 2a of the printed-wiring board 2 is inserted in the housing 1 from the opening 21. The edge portion 2a of the printed-wiring board 2 inserted into the housing 11 from the opening 21 is accommodated in an cavity 20 communicating to the outside through the opening 21. As shown in FIG. 3, the cavity 20 is formed to extend a length of approximately two-third of the housing 11 with respect to the inserting direction of the printed-wiring board 2 (or in a depth direction of the housing 11).

The cavity 20 has (i) a number of first grooves 22 for the first contacts 12 to be inserted in the housing 11 from the rear side thereof (from the side opposite to the opening 21) and also support the first contacts 12 inserted and (ii) a number of second grooves 23 for the second contacts 13 to be inserted-in the housing 11 from the front side thereof (from the side on the opening 21 side) and also support the second contacts 13 inserted. The first grooves 22 and the second grooves 23 are arrayed in parallel and alternatively along the extending direction of the opening 21. The first grooves 22 and the second grooves 23 are both formed to extend to an upper region of the opening 21, whereas the first grooves 22 are formed not to extend to a lower region of the opening 21 and only the second grooves 23 are formed to extend to the lower region of the opening 21.

As shown in FIG. 2, the housing 11 has a first window 24 and a second window 25 to communicate with the cavity 20 which are formed on the top surface of the housing 11 (which extends along a direction substantially parallel to the inserting direction of the printed-wiring board 2) at two locations near the both ends thereof with respect to the extending direction of the opening 21. The first window 24 and the second window 25 are formed to expose an area in the vicinity of the deepest portion of the cavity 20 to the outside, so that when the edge portion 2a of the printed-wiring board 2 is in the state of being fully accommodated in the cavity 20, the contact between the first contacts 26 of the printed-wiring board 2 and the first contacts 12 can be visually observed directly through the first window 24 and the second window 25.

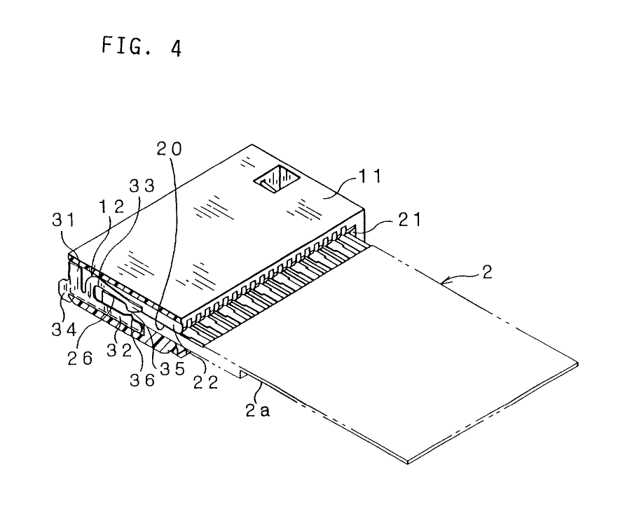

As shown in FIG. 4, a number of first grooves 22 are arrayed in the cavity 20 along the extending direction of the opening 21. The first contacts 12 inserted in the housing 11 from the side opposite to the opening 21 of the housing 11 are supported in the housing 11 by the first grooves 22. The first contacts 12 are formed by stamping a sheet metal such as a copper alloy, each having a base portion 31 fitted in a rear end portion of the first groove 22 and fixed thereat, an arm 32 extending along a lower portion of the first groove 22 from the base portion 31, a vertically elastically deformable beam 33 rising upwardly from a portion of the arm 32 and then extending toward the opening 21 along an upper portion of the first groove 22, and a lead portion 34 projected downwardly from a rear end portion of the base portion 32. The beam 33 is provided at, a front end portion thereof, with a contact point 35 to the first contact 26 of the printed-wiring board 2. The arm 32 is provided, at a portion thereof, with a bearing point 36 opposing to the contact point 35. When the edge portion 2a of the printed-wiring board 2 is inserted into the cavity 20 from the opening 21, the beams 33 of the first contacts 12 are elastically deformed in the upward direction, while they are biased toward the printed-wiring board 2 to bring the contact points 35 into contact with the first contacts 26.

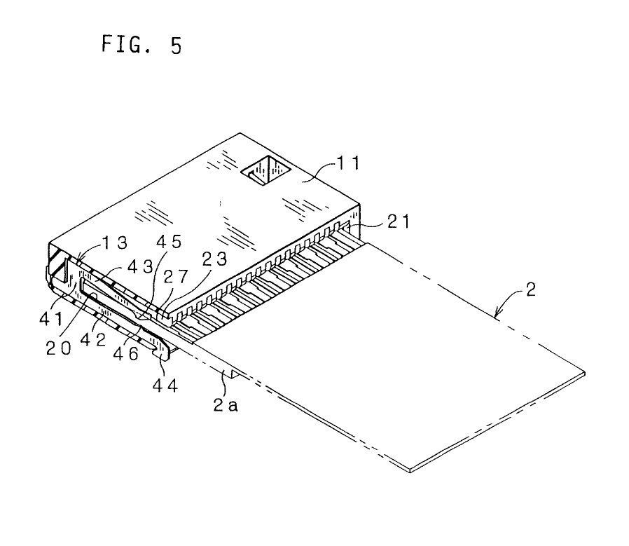

As shown in FIG. 5, a number of second grooves 23 are arrayed in the cavity 20 along the extending direction of the opening 21. The second contacts 13 inserted in the housing 11 from the side on the opening 21 side of the housing 11 are supported in the housing 11 by the second grooves 23. The second contacts 13 are formed by stamping a sheet metal such as a copper alloy, each having a base portion 41 fitted in a rear end portion of the second groove 23 and fixed thereat, an arm 42 extending along a lower portion of the second groove 23 from the base portion 41, a vertically elastically deformable beam 43 extending from an upper end of the base portion 41 toward the opening 21 along the upper portion of the second groove 23, and a lead portion 44 projected downwardly from a front end portion of the arm 42. The beam 43 is provided at, a front end portion thereof, with a contact point 45 to the second contact 27 of the printed-wiring board 2. The arm 42 is provided, at a portion thereof, with a bearing point 46 opposing to the contact point 45. When the edge portion 2a of the printed-wiring board 2 is inserted into the cavity 20 from the opening 21, the beams 43 of the second contacts 13 are elastically deformed in the upward direction, while they are biased toward the printed-wiring board 2 to bring the contact points 45 into contact with the second contacts 27.

As seen from the comparison between FIGS. 4 and 5, the first contacts 12 and the second contacts 13 are alternately arranged in the longitudinal direction of the housing 11 (i.e., in the arranging direction of the first contacts 26 and the second contacts 27). In addition, the contact points 35 of the first contacts 12 are placed in the cavity 20 at positions deeper than the contact points 45 of the second contacts 13. When the printed-wiring board 2 is inserted in the cavity 20 from the opening 21, the second contacts 13 comes into contact with the edge portion 2a of the printed-wiring board 2, first, and then the first contacts 12 comes into contact with the edge portion 2a of the printed-wiring board 2. Consequently, the force required for insertion of the printed-wiring board 2 into the cavity 20 is dispersed and thus reduced. Thus, in the connector 1 for printed-wiring board of the embodiment of the present invention, since the force required for insertion of the edge portion 2a of the printed-wiring board 2 into the cavity 20 is reduced to an extent to which it comes to be hard for an operator to get a tactile sense of insertion of the connector, the visual check that the printed-wiring board 2 is fully inserted to a specified position of the cavity 20 is effectively performed.

As seen from FIGS. 4 and 5, since the lead portions 34 of the first contacts 12 are projected downwardly from the rear end of the housing 11 and the lead portions 44 of the second contacts 13 are projected downwardly from the front end of the housing 11, the housing 11 can be mounted on the printed-wiring board with ease, as compared with the case where the lead portions 34 and the lead portions 44 are projected from the ends of the same side of the housing 11.

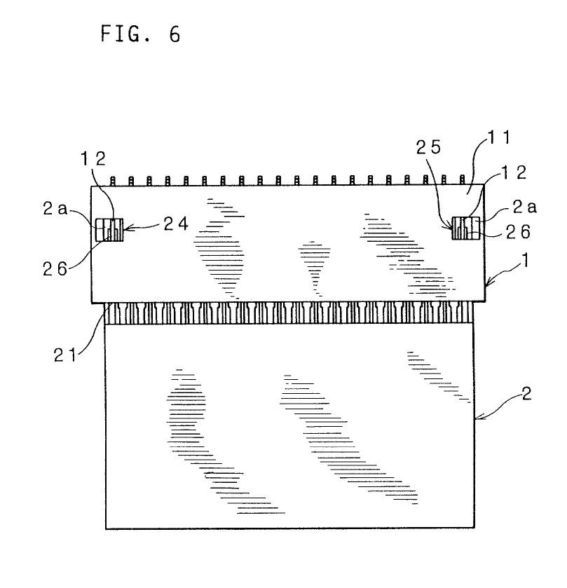

As shown in FIG. 6, when the housing 11 of the connector 1 in which the printed-wiring board 2 was inserted is viewed from the above, the first contract 12 and the edge portion 2a of the printed-wiring board 2 are viewable from the first window 24 and the second window 25. In the connector 1 of the illustrated embodiment, the operator ascertains that a front end of the edge portion 2a is viewless from the first window 24 and the second window 25 (in other words, the fact that the front end of the edge portion 2a is placed in the deepest position of the cavity 20), from which the operator can see that the printed-wiring board 2 is suitably inserted to the specified position where the first contacts 12 of the connecter 1 and the first contacts 26 of the printed-wiring board 2 are in contact with each other and also the second contacts 13 of the connector 1 and the second contacts 27 of the printed-wiring board 2 are in contact with each other. In addition, the operator ascertains that the first contacts 26 of the printed-wiring board 2 viewable from the first window 24 and the second window 25 are set in position with respect to the first contact 12, from which the operator can clearly see that the printed-wiring board 2 is fully inserted in the housing 11. Further, in the connector 1 of the illustrated embodiment, the operator makes a comparison between the state of the printed-wiring board 2 viewable from the first window 24 and the state of the printed-wiring board 2 viewable from the second window 25, from which the operator can ascertain that the printed-wiring board 2 is not inserted in the tilted state with respect to the cavity 20. Thus, the connector 1 for printed-wiring board of the illustrated embodiment can prevent the failure of connection to the printed-wiring board 2 from occurring. Accordingly, the connector 1 for printed-wiring board of the illustrated embodiment can prevent failure of the connection to the printed-wiring board 2.

While there have been shown herein and described certain preferred embodiments of the invention, various design changes and modification may be made within the scope of the claimed invention without limiting to the illustrated embodiment. For example, the windows, the cavity and the grooves can be changed in shape properly. While in the illustrated embodiment, the housing 11 has the two windows (the first window 24 and the second window 25), it may alternatively have a single window. In this case, no particular limitation is imposed on the location for the window to be formed in the housing, as long as the full insertion of the printed-wiring board 2 in the cavity 20 can be visually ascertained from the window at that location. Alternatively, the housing 11 may have three or more windows. The first window 24 and the second window 25 may be formed into any proper shape, such as a circular shape, without limiting to rectangular or square. Also, the first window 24 and the second winder 25 may be formed in positions corresponding to the second contacts 13 and the contacts of the printed-wiring board 2, rather than in positions corresponding to the first contacts 12 and the contacts of the printed-wiring board 2.

While in the illustrated embodiment, the printed-wiring board 2 has the circuit pattern 16 on the top surface thereof and the first and second contacts 12, 13 have the contact points 35, 45 on the upper side thereof and the bearing points 36, 46 on the lower side thereof, respectively, the modification may be made, such that the printed-wiring board 2 has the circuit pattern 16 on the bottom surface thereof the contacts and the bearing points of the first and second contacts 12, 13 are reversed upside down; and the windows 24, 25 are formed on the top surface of the housing 11. In this modification also, through the visual check of the windows 24, 25 the operator can ascertain that the printed-wiring board 2 is fully plugged into the specified position of the connector and that the printed-wiring board 2 is inserted in the connector without any tilt.

The provision of the window to communicate with the cavity can be applied to another type of connector for printed-wiring board wherein the housing has a slider and the edge portion of the printed-wiring board is inserted in the housing from the opening, with the slider open, and the closing of the slider brings the contacts into contact with the circuit pattern of the printed-wiring board. In this case also, the provision of the window to the housing having the slider enables the operator to ascertain the insertion of the printed-wiring board in the cavity through the visual check of the window.

What is claimed is:

1. A connector for a printed-wiring board comprising:
a housing including an accommodating cavity for accommodating an edge portion of said printed-wiring board having a circuit pattern formed thereon;
a plurality of contacts which are supported in a plurality of grooves provided in said cavity, respectively, and comes into contact with said circuit pattern of said printed-wiring board while said edge portion of said printed-wiring board is in said cavity; and
at least one window formed in said housing that permits at least a part of said printed-wiring board to be visually checked from outside of said housing while said edge portion of said printed-wiring board is in said cavity.

2. The connector for printed-wiring board according to claim 1, wherein at least two windows are located at an interval spaced along the extending direction of said cavity.

3. The connector for printed-wiring board according to claim 1, wherein said at least one window is formed at a location corresponding to a preset contacting point of said circuit pattern formed in said printed-wiring board and said contacts.

4. The connector for printed-wiring board according to claim 1, wherein said contacts include two types of contacts, first contacts and second contacts, whose contacting positions with said circuit pattern are staggered relative to one another in the inserting direction of said printed-wiring board, and said first contacts and said second contacts are alternately supported in the plurality of grooves.
